(19) United States
(12) Patent Application Publication
(10) Pub. No.: US 2021/0227855 A1
(43) Pub. Date: Jul. 29, 2021

(54) METHODS AND COMPOSITIONS FOR REDUCING CAFFEINE SIDE EFFECTS

(71) Applicant: Seattle Gummy Company, Seattle, WA (US)

(72) Inventors: Feng Wan, Issaquah, WA (US); William Carlson, Shoreline, WA (US)

(21) Appl. No.: 16/972,009

(22) PCT Filed: Jun. 20, 2019
(86) PCT No.: PCT/US2019/038232

§ 371 Date: Dec. 4, 2020

Related U.S. Application Data
(60) Provisional application No. 62/689,106, filed on Jun. 23, 2018.

(51) Int. Cl. A23L 2/56; A23F 5/36; A23F 3/30

(52) U.S. Cl. CPC A23L 2/56; A23F 3/30; A23F 5/36

(57) ABSTRACT

An edible composition, comprising a caffeinated composition and a modulating composition, wherein the modulating composition comprises an adrenergic receptor antagonist, an adrenergic receptor agonist, a calcium channel blocker, an ACE inhibitor, an angiotensin II receptor antagonist, an aldosterone antagonist, a vasodilator, a centrally acting adrenergic compound, a PAF receptor inhibitor, or a combination thereof. In one embodiment, the edible composition comprises at least 1% caffeine by weight. In one embodiment, the modulating composition comprises powder, extract, isolate or derivative of a herb comprising danshen (Salvia miltiorrhiza), Pueraria lobata, danggui, guan-mu-tong (Aristolochia manshuriensis), Chinese Hawthorn (Crataegus pinnatifida), pima cotton (Gossypium barbadense), Hibiscus sabdariffa, Actinidia arguta radix (Tengligen), Peucedani radix (Qianhu), Spatholobi caulis (Jixueteng), Schisandra (Schisandra chinensis), Jiaogulan (Gynostemma pentaphyllum), Gotu Kola (Centella asiatica), Ginkgo biloba, or a combination thereof.

### CROSS-REFERENCES TO RELATED APPLICATIONS

This application claims the benefit of priority from, and hereby incorporates by reference the entire disclosure, co-pending U.S. Provisional Application for Patent Ser. No. 62/689,106, filed Jun. 23, 2018.

### TECHNICAL FIELD

### The application relates generally to compositions and methods for reducing caffeine's jittery side effects.

### BACKGROUND

Caffeine is a bitter-tasting compound. The xanthine core of caffeine contains two fused rings, a pyrimidinedione and imidazole. Pharmacologically, caffeine stimulates central nervous system (CNS), heart, muscles, and centers that control blood pressure. The compound is known to cross the blood brain barrier and reversibly blocks the action of adenosine on its receptor and consequently prevents the onset of drowsiness induced by adenosine. Caffeine also stimulates certain portion of the autonomic nervous system.

The undesired side effects from caffeine ingestion are common, including heart palpitation, increased heart rate and respiration, nausea, nervousness and restless, mild anxiety, jitteriness, insomnia, increase sleep latency and reduced coordination. Researches have positively associated caffeine use with anxiety and panic disorders.

There is a need for compositions and methods for reducing anxiolytic and craniological side effects caused by caffeine, reducing bitterness taste, or both.

### SUMMARY

In one aspect, the application provided edible compositions for reducing caffeine's side effects. In one embodiment, the edible composition includes a caffeinated composition and a modulating composition, wherein the modulating composition is configured to modulate or reduce caffeine's side effect. The side effects from caffeine that is modulated, reduced or counteracted include without limitation cardiovascular side effects (such as heart jittery, increased heart rate, high blood pressure) and CNS side effects (such as nausea, nervousness, restless, anxiety, jittery, insomnia, and coordination problems).

The caffeinated composition may be natural caffeine, synthetic caffeine, caffeine-containing plant extract or powder, or a combination thereof. In some embodiments, the caffeinated composition comprises caffeine, green coffee bean powder or extract, green tea powder or extract, white tea powder or extract, black tea powder or extract, guarana powder or extract, yerba mate powder or extract, cola nut powder or extract, cacao powder or extract, coffee powder or extract, or a combination thereof. In one embodiment, the caffeinated composition consists essentially of caffeine.

In one embodiment, the edible composition comprises at least 0.1% caffeine by weight. In one embodiment, the edible composition comprises at least 0.5%, 0.8%, 1%, 1.5%, 2%, 2.5%, or 3% caffeine by weight. In one embodiment, the edible composition comprises at least 10% caffeine by weight. In one embodiment, the edible composition comprises at least 20% caffeine by weight. In some embodiments, the edible composition includes from about 0.001% to about 10% caffeine by weight. In some embodiments, the edible composition includes from about 1% to about 50% caffeine by weight. In some embodiments, the edible composition includes from about 10% to about 80% caffeine by weight.

In one embodiment, the edible composition may include not less than 50 mg per dose, not less than 100 mg per dose, not less than 200 mg per does, not less than 300 mg per dose, not less than 400 mg per dose, or not less than 400 mg per does.

The modulating composition is configured to reduce or counter act caffeine's side effect including without limitation jittery or anxiety. In one embodiment, the modulating composition comprises adrenergic receptor antagonist, adrenergic receptor agonist, calcium channel blocker, ACE inhibitor, angiotensin II receptor antagonist, aldosterone antagonist, vasodilator, centrally acting adrenergic compound, PAF receptor inhibitor, or a combination thereof. In one embodiment, the modulating composition comprises compounds that are configured to antagonize platelet activation factor (PAF), improve alpha-2 adrenoreceptor activity, catechol-O-methyl transferase (COMT), dilate blood vessels, increase level of 5-hydroxytryptamine (5-HT) in the hippocampus, or a combination thereof.

In some embodiments, the modulating composition comprises gingko biloba, cocoa, theobromine, theanine, piraletam, citicoline, blubbery extract or isolates, arginine, vitamin E, bacopa, curcumin, ginseng, citrulline, icariin, forsklin, S-denosyl-L-methionine, quercetine, taurine, grape seed extract, or isolates, extracts or derivatives thereof.

In some embodiments, the modulating composition comprises vasodilating agent, and wherein the vasodilating agent comprises powder, extract, isolate or derivative of a herb comprising danshen (Salvia miltiorrhiza), Pueraria lobata, danggui, safflower, Annona muricate, guan-mu-tong (Aristolochia manshuriensis), Cassia absus, Chinese Hawthorn (Crataegus pinnatifida), pima cotton (Gossypium barbadense), Hibiscus sabdariffa, Musanga cecropiodes, Uncaria rhynchophylla, Actinidia arguta radix (Tengligen), Glycyrrhizae radix et rhizoma (Gancao), Peucedani radix (Qianhu), Spatholobi caulis (Jixueteng), Schisandra (Schisandra chinensis), Jiaogulan (Gynostemma pentaphyllum), Gotu Kola (Centella asiatica), Ginkgo biloba, Ginger root, Catuaba (Erythroxylum catuaba), Korean red ginseng, or a combination thereof.

In some embodiments, the modulating composition comprises danshen, danggui, safflower, red clover, wild yam, American ginseng, valerian, St. John's wort, goldenseal, turmeric, grape seed, slippery elm, cayenne, Devil's Claw, feverfew, Jamaica dogwood, linden, willow bark, peppermint, barberry, celery seed, dandelion, Gotu Kola, bilberry, Asian ginseng, green tea, rosemary, Siberian ginseng, saw palmetto, ashwagandha, bacopa monnieri, hordenine, isoflavones, kava kava, cat's claw (Uncaria tomentosa, Uncaria guianensis), lavender, cinnamon (Cinnamomum verum), Yarrow (Achilea millefolium), hawthorn, garlic, Buchu (Agathosma betulina), prickly custard apple (Annona muricata), Cassia occidentalis (Coffee weed), hibiscus sabdariffa (Roselle), blackberry, blueberry, raspberry, acai berry, goji berry, or plant parts, extract, isolates or powders thereof.

In some embodiments, the modulating composition comprises ginkgo biloba leave extract, ginkgo biloba flavonoids, cocoa flavonoids, or a combination thereof. In some embodiments, the modulating composition comprises epicatechin, catechin, quercetin, kaempferol, isorhamnetin, amentoflavone, bilobetin, isoginkgetin, ginkgetin, sciadopitysin, or a combination thereof.

In some embodiments, the modulating composition comprises gingko biloba, its isolates, extracts or powders thereof. In some embodiments, the modulating composition comprises danshen isolates, extracts or powders thereof. In some embodiments, the modulating composition comprises danggui isolates, extracts or powders thereof. In some embodiments, the modulating composition comprises grade seed isolates, extracts or powders thereof.

The edible composition may further include a flavor-masking agent. The flavor-masking agent is configured to reduce the over bitterness of the edible composition.

In one embodiment, the flavor-masking agent is capable of interacting with the caffeinated composition and reducing the bitterness from the caffeinated composition. For example, the flavor-masking agent may be capable of interacting with the caffeinated composition through coordinating, complexing, chelating, hydrogen-bonding, dipole-dipole interaction, van-der waals interaction, or a combination thereof.

In one embodiment, the flavor-masking agent comprises nucleic acid, DNA, RNA, plant nucleic acid, berry nucleic acid, fruit nucleic acid, melon nucleic acid, protein, peptide, cluster dextrin, cyclodextrin, polydextrose, resistant starch, porphyrin, polyethylene glycol, polyunsaturated hydrocarbons, polyunsaturated fatty acids, block copolymers, ricin oleic acid, ricin oil, mica, talc, zeolite, silica, cellulose, lignin, plant particles, MOF, calcium carbonate, diatomaceous earth, chitosan, poly N-acetoglucosamine, taurine, mannitol, mannose, or a combination thereof. In one embodiment, the plant particles are derived from husk, seed, seed shell, nut, nut shell, fruit, flower, stem, leaf, rice husk, nut shell, woody root, stem or leaves, corn husk, oat husk, grain husk, yeast, mushroom, berry fruit or berry seed, raspberry fruit or seed, blackberry fruit or seed, blueberry fruit or seed, strawberry fruit or seed, Goji berry fruit or seed, mellon, vegetables such as (without limitation) bell pepper sand egg plant, or a combination thereof.

The edible composition may further comprise an antioxidant composition, a vitamin composition, a mineral composition, an amino acid composition, or a synergistic composition. The antioxidant composition comprises Vitamin E, Vitamin C, beta-carotene, gallic acid, selenium, selenium yeast, phenolics, anthocyanins, flavonoids, theobromine, anthracenes, carotenoids, lutein, zeaxanthin, gingko leave or fruit extract or powder, blackberry extract, elderberry extract, cranberry extract, blueberry extract, grapeseed extract, resveratrol, saffron, Sangre de grado (dragon's blood), cocoa, or derivatives thereof.

The vitamin composition comprises vitamin A, B, C, D, E, K or a combination thereof. In one embodiment, the vitamin composition comprises vitamin Bs. In one embodiment, the edible composition may include, per serving, from about 50% to about 100% daily value of niacin, from about 50% to about 2000% of vitamin B6 (pyridoxine hydrochloride), from about 50% to about 10,000% of vitamin B 12 (cyanocobalamin), from about 50% to about 800% of folic acid, from about 50% to about 200% of pantothenic acid, or a combination thereof.

The mineral composition comprises salts of calcium, iron, zinc, magnesium, sodium, chloride, potassium, copper, molybdenum, manganese, phosphorus, iodine, nickel, or selenium, or a combination thereof. In one embodiment, the mineral composition comprises sodium, potassium and calcium salts. In one embodiment, the mineral composition comprises sodium and potassium salts.

The amino acid composition may comprise at least one essential amino acid or its derivative thereof. In one embodiment, the amino acid composition comprises branched chain amino acids. In one embodiment, the amino acid composition comprises valine, leucine and isoleucine. In one embodiment, the amino acid composition comprises tryptophan, glutamine, aspartate, arginine, ornithine, lysine, arginine, tyrosine, taurine, beta-alanine, carnitine, or the derivatives thereof.

The synergistic composition may serve to enhance caffeine's effect. In one embodiment, the synergistic composition comprises magnesium, L-theanine, theobromine, or a combination thereof.

In one embodiment, the edible composition may include an additive. The additive may include sweeteners, food acids, flavoring agents, coloring agents, humectants, bulking agents, fatty acids, triglycerides, plasticizers, emulsifiers, thickeners, preservatives, or and a mixture thereof.

In one embodiment, the sweetener comprises erythritol, xylitol, sugar, glucose syrup, corn syrup, high fructose corn syrup, juice concentrate, tapioca syrup, agave syrup, brown rice syrup, high maltose syrup, invert sugar, artificial sweeteners, saccharin, saccharin salts, monk fruit extract, cyclamic acid, cyclamic acid salts, aspartame, sucralose, acesulfame, rebaudioside A, rebaudioside B, rebaudioside C, rebaudioside D, rebaudioside E, dulcoside A, dulcoside B, rubusoside, stevia, stevioside, mogroside IV, mogroside V, Luo Han Guo (monk fruit) sweetener, thaumatin, extract or isolate of thaumatococcus danielli, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, acesulfame potassium and other salts, aspartame, alitame, saccharin, neohesperidin dihydrochalcone, cyclamate, neotame, N-[N-[3-(3-hydroxy-4-methoxyphenyl)propyl]-L-alpha.-aspartyl]-L-phenylalanine 1-methyl ester, N-[N-[3-(3-hydroxy-4-methoxyphenyl)-3-methylbutyl]-L-alpha-aspartyl]-L-phenylalanine 1-methyl ester, N-[N-[3-(3-methoxy-4-hydroxyphenyl)propyl]-L-alpha-aspartyl]-L-phenylal-anine 1-methyl ester, salts thereof, licorice or its extracts or isolates, or a mixture thereof.

In one embodiment, the flavoring agent comprises vanilla, chili oil, gingerol, peperine, capsaicin, peppermint oil, spearmint oil, eucalyptus oil, cinnamon oil, grapefruit oil, menthol, mono-menthyl succinate, menthol ethylene glycol carbonate, menthone glycerol ketal, menthyl lactate, (−)-isopulegol, p-menthane-3,8-diols, (−)-monomenthyl glutarate, oil of wintergreen (methylsalicylate), citrus oils, orange oils, fruit essences, Rosemary Oil, lavender oil, sage oil, clary sage oil, thyme oil, sandalwood oil, basil oil, coriander oil, cypress oil, fleabane oil, frankincense oil, geranium oil, fennel oil, oregano oil, Dalmatian sage oil, tarragon oil, cocoa, pineapple flavor, or mixtures or derivatives thereof.

In one embodiment, the application provides food or beverage comprising the edible composition. The food and beverage may be liquid, solid or semi-solid. In one embodiment, the food may be in powdered form. Examples of the powdered form include an instant coffee blend, an instant tea blend, a protein blend, a chocolate drink blend, an energy bar, a concentrated drink powder (for sports drink, for example), a concentrated energy drink powder, or a concentrated vitamin drink powder. In one embodiment, the food may be a caffeinated candy, a caffeinated chew, or a chewing gum. In one embodiment, the beverage may be an energy drink, an energy shot, a coffee drink, a tea drink, a soda, a diary drink, a protein drink, or a carbonated drink. In one embodiment, the food may be syrup.

In some embodiments, the food or beverage composition may be medicated. In some embodiments, the application may provide a medication or pharmaceutical composition comprising the caffeine composition as disclosed herein.

In another aspect, the application provides methods for reducing the side effect from an edible composition. In one embodiment, the method includes providing a modulating composition, and co-administering to a subject the modulating composition with the edible composition. In one embodiment, the modulating composition may be a companion composition for an edible composition, a coffee mate, or a companion pack for a caffeinated product such as tea.

In one embodiment, the application provides a kit comprising a modulating composition and an instruction for mixing the modulating composition with an edible composition or co-administering the modulating composition with the edible composition.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1 shows the chemical structure of alpha-, beta- and gamma-cyclodextrin;

FIG. 2 shows the example complexing interaction between caffeine molecule and DNA or RNA base pairs; and

FIG. 3 shows an example block copolymer and the formation of an example hydrophilic shell-hydrophobic core structure.

### DETAILED DESCRIPTION

The application provides edible composition for reducing caffeine's jittery side effect. In one embodiment, the composition comprises a modulating composition configured to reduce, modulate, or counteract the side effects of caffeine. In one embodiment, the modulating composition is configured to reduce or counter act the side effects of caffeine such as jittery and anxiety. In one embodiment, the modulating composition comprises adrenergic receptor antagonist, adrenergic receptor agonist, calcium channel blocker, ACE inhibitor, angiotensin II receptor antagonist, aldosterone antagonist, vasodilator, centrally acting adrenergic compound, PAF receptor inhibitor, or a combination thereof. In one embodiment, the modulating composition is configured to antagonize platelet activation factor (PAF), improve alpha-2 adrenoreceptor activity, catechol-O-methyl transferase (COMT), dilate blood vessels, increase level of 5-hydroxytryptamine (5-HT) in the hippocampus, or a combination thereof.

In one embodiment, the modulating composition comprises gingko biloba, cocoa, theobromine, theanine, piraletam, citicoline, blubbery extract or isolates, arginine, vitamin E, bacopa, curcumin, ginseng, citrulline, icariin, forsklin, S-denosyl-L-methionine, quercetine, taurine, or isolates, extracts or derivatives thereof. In one embodiment, the modulating composition comprises cat's claw (Uncaria tomentosa, Uncaria guianensis), lavender, cinnamon (Cinnamomum verum), Yarrow (Achilea millefolium), hawthorn, garlic, Buchu (Agathosma betulina), prickly custard apple (Annona muricata), Cassia occidentalis (Coffee weed), Hibiscus sabdariffa (Roselle), or a combination thereof.

In one embodiment, the caffeine comprises natural caffeine, synthetic caffeine, or a combination thereof. In one embodiment, the caffeinated composition comprises a caffeine-containing plant extract or powder. In one embodiment, the caffeinated composition comprises caffeine, green coffee bean powder or extract, green tea powder or extract, white tea powder or extract, black tea powder or extract, guarana powder or extract, yerba mate powder or extract, cola nut powder or extract, cacao powder or extract, coffee power or extract, or a combination thereof. In one embodiment, the caffeinated composition comprises caffeine and cacao powder.

In one embodiment, the composition further comprises a flavor-masking agent, wherein the flavor-masking agent is capable of interacting with caffeine and modulates caffeine's bitterness. In one embodiment, the flavor-masking agent is capable of interacting with caffeine and forming a caffeinated complex therefore reducing or masking the bitterness from caffeine.

In one embodiment, the flavor-masking agent is capable of interacting with caffeine molecule through coordinating, chelating, complexing, hydrogen-bonding, dipole-dipole interaction, van-der waals interaction, or a combination thereof. The caffeinated complex is capable of masking, lessening or reducing caffeine's bitterness taste. In one embodiment, the flavor-masking agent is capable of interacting with non-caffeine natural products in a composition to be modulated (such as coffee, tea, or chocolate) so the overall bitterness of the composition to be modulated is reduced. The non-caffeine natural products may include polyphenol, theobromine, flavonoids, other alkaloids, or a combination thereof.

In one embodiment, the flavor-masking agent comprises nucleic acid, DNA, RNA, protein, peptide, cluster dextrin, cyclodextrin, polydextrose, resistant starch, porphyrin, polyethylene glycol, polyunsaturated hydrocarbons, polyunsaturated fatty acids, ricin oleic acid, ricin oil, mica, talc, zeolite, silica, cellulose, lignin, plant particles, MOF, calcium carbonate, diatomaceous earth, chitosan, poly N-acetoglucosamine, block copolymers, or a combination thereof.

Cyclodextrins (sometimes called cycloamyloses) are a family of compounds made up of sugar molecules bound together in a ring (cyclic oligosaccharides). Cyclodextrins are composed of 5 or more α-D-glucopyranoside units linked 1->4. Typical cyclodextrins contain a number of glucose monomers ranging from six to eight units in a ring, creating a cone shape. The largest cyclodextrin contains 32 1,4-anhydroglucopyranoside units. α (alpha)-cyclodextrin is a 6-membered sugar ring molecule.

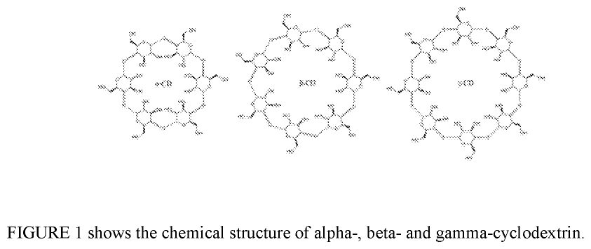

As shown in FIG. 1, β (beta)-cyclodextrin is a 7-membered sugar ring molecule. γ (gamma)-cyclodextrin is a 8-membered sugar ring molecule. Alpha-, beta-, and gamma-cyclodextrin are all generally recognized as safe by the FDA. Alpha is limited to 3% by weight of the product being consumed whereas beta has a dietary limit of 50 mg/kg. There are no dietary limits on gamma-cyclodextrin. The interior of the cyclodextrin, be it alpha, beta or gamma, is extraordinarily hydrophobic while the exterior of the cyclodextrin is hydrophilic making it ideal to mask bitter tasting natural produces such as bisphenol, theobromine, alkaloids, or a combination thereof.

In one embodiment, the flavor-masking agent comprises alpha-cyclodextrin, beta-cyclodextrin, gamma-cyclodextrin, or a combination thereof. In one embodiment, the flavor-masking agent consists essentially of alpha-cyclodextrin. In one embodiment, the flavor-masking agent consists essentially of beta-cyclodextrin. In one embodiment, the flavor-masking agent consists essentially of gamma-cyclodextrin.

In one embodiment, the flavor-masking agent may comprise cyclodextrin and a biophenol. The biophenol may form complex with cyclodextrin and caffeine. In one embodiment, the biphenol-caffein-cyclodextrin complex may be more stable than caffeine-cyclodextrin complex. In one embodiment, the biophenol comprises tyrosol, oleuropein, or a combination thereof. In one embodiment, the biophenol comprises polyphenols such as flavonoids.

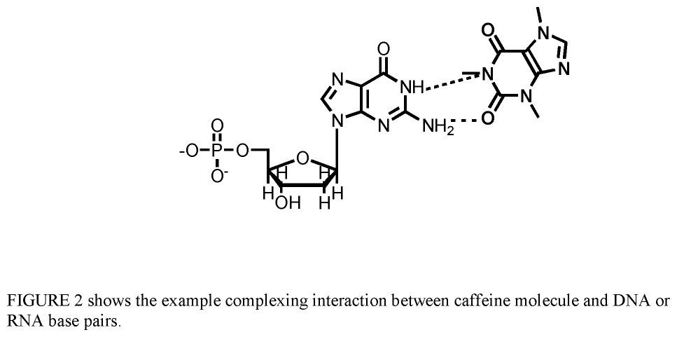

In one embodiment, the flavor-masking agent comprises a nucleic acid molecule. In one embodiment, the nucleic acid molecule may be a DNA molecule (FIG. 2). Caffeine is similar in structure to DNA and RNA base pairs. Being similar in structure and functionality the caffeine molecule is able to hydrogen bond with the base pairs and form a DNA-caffeine complex. The complex helps to lessen the bitterness of the caffeine. The DNA molecule may form a DNA-caffeine complex therefore shielding the bitterness of caffeine. In one embodiment, the DNA-caffeine complex may have an arrangement in which the caffeine molecule is complexed with DNA double helix with an orientation parallel to the bases. In one embodiment, the caffeine molecule complexes with DNA double helix through hydrogen bonding. In one embodiment, the flavor-masking agent comprises DNA molecules from plant source. In one embodiment, the flavor-masking agent comprises strawberry DNA. In one embodiment, the flavor-masking agent comprises fruit DNA. In one embodiment, the flavor-masking agent comprises plant DNA. In one embodiment, the flavor-masking agent comprises melon DNA.

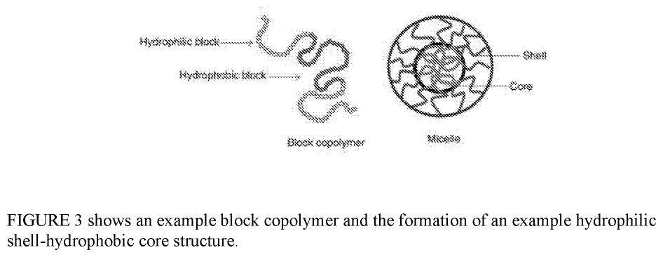

In one embodiment, the flavor-masking agent comprises a block copolymer. In one embodiment, the block copolymer may be a hydrophobic block linked to a hydrophilic block (FIG. 3). As shown in FIG. 3, the assembling of hydrophobic parts of the block copolymers forms the inner micelle core in water medium through hydrophobic interactions, whereas the outer hydrophilic parts surround the inner core as a hydrated shell. Example block polymers may include poly(oxyethylene), polystyrene-block-poly(oxytehylene) copolymer,

[symbol]

In one embodiment, the plant particles are derived from husk, seed, seed shell, nut, nut shell, fruit, flower, stem, leaf, rice husk, nut shell, woody root, stem or leaves, corn husk, oat husk, grain husk, yeast, mushroom, fruit, pulp or seed, melon, or a combination thereof. In one embodiment, the plant particle comprises berry fruit or seed, raspberry fruit or seed, blackberry fruit or seed, blueberry fruit or seed, strawberry fruit or fruit, eggplant, bell pepper, goji berry fruit or seed, longan berry fruit or seed, lychee fruit, dates, jujube, citrus fruit or peel, pear, or a combination thereof. In one embodiment, the plant particles comprised defatted berry seed particles. In one embodiment, the plant particles have a particle size from about at least 70 mesh. In one embodiment, the plant particle has a particle size from about 70 to about 200 mesh. In one embodiment, the plant particle has a particle size of not greater than about 200 mesh. In one embodiment, the plant particle has a particle size of from about 100 to about 500 mesh.

In one embodiment, the molar ration of flavor-masking agent and caffeine or natural products (such as alkaloids, bisphenols, or flavonoids from the composition to be modulated) is from about 1:1 to about 100:1. In one embodiment, the molar ration of flavor-masking agent and caffeine is at least 1:1, 2:1, 5:1, 10:1, 100:1, or any ratio in between.

The composition can contain surprisingly high concentration of caffeine without significant caffeine side effects experience a user. In one embodiment, the composition comprises at least 0.5%, 0.7% or 0.8% caffeine by weight. In one embodiment, the composition comprises at least 1%, 1.5%, 2%, 2.5%, 3%, 3.5%, 4% or 5%, 10%, 20%, 30%, 40%, 50%, 60%, 70%, 80%, 90% caffeine by weight. In one embodiment, the composition comprises more than 5% caffeine by weight. The weight percentage of caffeine can be any percentage between the numbers mentioned above. In one embodiment, the composition comprises at least 0.5% of caffeine and magnesium.

The composition may further comprise an antioxidant composition, an anti-inflammatory composition, a vitamin composition, a mineral composition, an amino acid composition, or a stimulant composition. In one embodiment, the antioxidant composition comprises Vitamin E, Vitamin C, beta-carotene, gallic acid, selenium, selenium yeast, phenolics, anthocyanins, flavonoids, theobromine, anthracenes, carotenoids, lutein, zeaxanthin, gingko biloba, blackberry extract, elderberry extract, cranberry extract, blueberry extract, grapeseed extract, resveratrol, saffron, Sangre de grado (dragon's blood), cocoa, danshen, danggui (Angelica sinesis) extract, or derivatives thereof. In one embodiment, the anti-inflammatory composition comprises powder, isolate, extract or derivate of ginger, willow bark, turmeric, curcumin, polyphenol, alkaloids, or a combination thereof.

In one embodiment, the vitamin composition comprises vitamin A, B, C, D, E, K or a combination thereof. In one embodiment, the mineral composition comprises salts of calcium, iron, zinc, magnesium, sodium, chloride, potassium, copper, molybdenum, manganese, phosphorus, iodine, nickel, or selenium, or a combination thereof. In one embodiment, the amino acid composition comprises at least one essential amino acid or its derivative thereof.

In one embodiment, the composition may further include an additive selected from sweeteners, food acids, flavoring agents, coloring agents, humectants, bulking agents, fatty acids, triglycerides, plasticizers, emulsifiers, thickeners, preservatives, or and a mixture thereof.

In one embodiment, the sweetener comprises erythritol, xylitol, sugar, glucose syrup, corn syrup, high fructose corn syrup, juice concentrate, tapioca syrup, agave syrup, brown rice syrup, high maltose syrup, invert sugar, artificial sweeteners, saccharin, saccharin salts, cyclamic acid, cyclamic acid salts, aspartame, sucralose, acesulfame, rebaudioside A, rebaudioside B, rebaudioside C, rebaudioside D, rebaudioside E, dulcoside A, dulcoside B, rubusoside, stevia, stevioside, mogroside IV, mogroside V, Luo Han Guo sweetener, thaumatin, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, sucralose, acesulfame potassium and other salts, aspartame, alitame, saccharin, neohesperidin dihydrochalcone, cyclamate, neotame, N-[N-[3-(3-hydroxy-4-methoxyphenyl)propyl]-L-.alpha.-aspartyl]-L-phenylalanine 1-methyl ester, N-[N-[3-(3-hydroxy-4-methoxyphenyl)-3-methylbutyl]-L-alpha-aspartyl]-L-phenylalanine 1-methyl ester, N-[N-[3-(3-methoxy-4-hydroxyphenyl)propyl]-L-alpha-aspartyl]-L-phenylal-anine 1-methyl ester, salts thereof, licorice or its extracts or isolates, or a mixture thereof.

In one embodiment, the flavoring agent comprises vanilla, chili oil, gingerol, peperine, capsaicin, peppermint oil, spearmint oil, eucalyptus oil, cinnamon oil, grapefruit oil, menthol, mono-menthyl succinate, menthol ethylene glycol carbonate, menthone glycerol ketal, menthyl lactate, (−)-isopulegol, p-menthane-3,8-diols, (−)-monomenthyl glutarate, oil of wintergreen (methylsalicylate), citrus oils, orange oils, fruit essences, Rosemary Oil, lavender oil, sage oil, clary sage oil, thyme oil, sandalwood oil, basil oil, coriander oil, cypress oil, fleabane oil, frankincense oil, geranium oil, fennel oil, oregano oil, Dalmatian sage oil, tarragon oil, cocoa, pineapple flavor, berry flavors or mixtures or derivatives thereof. In one embodiment, the berry flavor comprises flavors, isolates, extracts, or juices of blueberry, raspberry, strawberry, black current, acai berry, bilberry, blackberry, mulberry, boysenberry, cranberry, elderberry, goji berry, gooseberry, huckleberry, or a combination thereof.

The coloring agent may be synthetic or natural. Example natural coloring agents include, without limitation, plant or fruit powder, isolate, extract or juice such as beet, strawberry, carrot, spirulina, cochineal, flower, turmeric extract or powder, curcumin, or a combination thereof.

In one embodiment, the composition comprises caffeine, gingko biloba, cocoa, and vitamin Bs, wherein the composition comprises at least 1.5, 2%, 3% or 5% caffeine by weight, wherein the flavor-masking agent comprises gamma-cyclodextrin and fruit powder, and wherein the modulating composition comprises gingko biloba, hawthorn extract, or a combination thereof. In one embodiment, the composition is raspberry flavored. In one embodiment, the composition is orange flavored.

In another aspect, the method of making the compositions is disclosed therein.

In a further aspect, the application provides methods for reducing caffeine side effects. In one aspect, the method comprises co-administering a modulating composition with a caffeinated composition. The modulating composition is configured to counteract, modulate or reduce caffeine's side effect. The administration can be simultaneous or in close time proximity.

In one embodiment, the modulating composition comprises gingko biloba. In one embodiment, the modulating composition comprises danshen (Chinese red sage) extract, isolate, powder or derivative. In one embodiment, the modulating composition comprises extract, powder, isolates or derivatives of propolis, sea cucumber, Pueraria lobata, red sage root (Radix Salvia miltiorrhiza), maybush (Crataegus pinnatifida Bunge), rhizoma alismatis (Alisma plantago-aquatica Linn.), largehead atractylodes rhizome (Rhizoma atractylodis macrocephalae), ginkgo (Ginkgo biloba L.), glossy ganoderma (Ganoderma lucidum), and curcuma root (Radix curcumae), Carthamustinctorius, or a combination thereof.

In one embodiment, the application provides a kit for reducing caffeine side effects. In one embodiment, the kid includes a modulating composition and an instruction. In one embodiment, the instruction instructs a user to mix the modulating composition with an edible composition before consuming the edible composition. In one embodiment, the instruction instructs a user to co-administering the modulating composition with the edible composition simultaneously or in close time proximity.

In one embodiment, the close time proximity means not more than 20 minutes apart. In one embodiment, the close time proximity means not more than 10 minutes, 5 minutes, 2 minutes or 1 minute apart. In one embodiment, the close time proximity means less than 5 minutes apart.

### EXAMPLES

### Example 1: Caffeinated Energy Shots

Ingredients: Purified Water, Maltodextrin, Taurine, Cyclodextrin, Glucuronic acid, Malic acid, N-acetyl L tyrosine, L-phenylalanine, caffeine, citicoline, Niacin, Ginko biloba, Vitamin B6, Folic Acid, Vitamin B12.

Method: To 401 kg of purified water heated to 50 ° C. are added 10.5 kg of maltodextrin, 2.5 kg glucuronic acid, 1.25 kg of cyclodextrin, and 1.25 kg of malic acid with stirring. The components are allowed to fully dissolve. In a separate container 1 kg of N-acetyl-L-tyrosine, 1 kg L-phenylalanine, 950 grams caffeine, 900 grams of citicoline, 300 grams niacin, 100 grams of ginkgo biloba powder, 6.0 grams pyridoxal 5′-phosphate, 4.0 grams folic acid, 2.5 grams hydroxocobalamin and blended until homogeneous. The mixture is then slowly added to the liquid phase with stirring. The mixture is then heated to 85° C. for thirty minutes at which time 55 grams of strawberry flavor is added. The solution is then chilled.

55 grams of product is designed to deliver: 95 mg caffeine, 90 mg citicoline, 100 mg L-phenylalanine, 100 mg N-acetyl-L-tyrosine, 30 mg Niacin, 600 mcg Vitamin B6, 400 mcg Folic Acid, 2.5 mcg Vitamin B12 and 10 mg gingko biloba.

### Example 2: Caffeinated Energy Shots

Ingredients: Purified Water, Maltodextrin, Taurine, Cyclodextrin, Glucuronic acid, Malic acid, N-acetyl L tyrosine, L-phenylalanine, caffeine, citicoline, Niacin, danshen extract, Vitamin B6, Folic Acid, Vitamin B12.

Method: To 401 kg of purified water heated to 50 ° C. are added 10.5 kg of maltodextrin, 2.5 kg glucuronic acid, 1.25 kg of cyclodextrin, and 1.25 kg of malic acid with stirring. The components are allowed to fully dissolve. In a separate container 1 kg of N-acetyl-L-tyrosine, 1 kg L-phenylalanine, 950 grams caffeine, 900 grams of citicoline, 300 grams niacin, 100 grams cacao powder, 100 grams of ginkgo biloba powder, 6.0 grams pyridoxal 5′-phosphate, 4.0 grams folic acid, 2.5 grams hydroxocobalamin and blended until homogeneous. The mixture is then slowly added to the liquid phase with stirring. The mixture is then heated to 85° C. for thirty minutes. The solution is then chilled.

55 grams of product is designed to deliver: 95 mg caffeine, 90 mg citicoline, 100 mg N-acetyl-L-tyrosine, 30 mg Niacin, 600 mcg Vitamin B6, 400 mcg Folic Acid, 2.5 mcg Vitamin B12 or 10 mg danshen extract.

### Example 3. Caffeinated Powdered Drink Concentrate

Ingredients: Sucrose, Maltodextrin, Fructose, Malic Acid, Sodium Citrate, Monopotassium Phosphate, Sodium Chloride, Calcium Lactate, Calcium Silicate Natural Flavors, Gum Arabic, Magnesium Oxide, Spirulina Powder, Caffeine, Schisandra extract.

Method: The following were blended together until homogeneous: 9.0 kg sucrose, 6.9 kg maltodextrin, 4.0 kg fructose, 2.0 kg malic acid, 900 grams sodium citrate, 500 grams potassium monophosphate, 146 grams sodium chloride, 140 grams calcium lactate, 140 grams calcium silicate, 100 grams gum Arabic, 100 grams spirulina powder, 96 grams caffeine, and 4.2 grams Schisandra extract.

To the homogeneous blend of powders is slowly sprayed added 140 grams of raspberry flavor. The mixture is tumbled until homogeneous.

24 grams of powder has: 300 mg sodium, 140 mg potassium, 95 mg caffeine, 10 mg Schisandra extract

### Example 4. Caffeinated Powdered Drink Concentrate

Ingredients: Sucrose, Maltodextrin, Fructose, Cocoa Powder, Malic Acid, Sodium Citrate, Monopotassium Phosphate, Sodium Chloride, Calcium Lactate, Calcium Silicate Natural Flavors, Gum Arabic, Magnesium Oxide, Spirulina Powder, Caffeine, Jixueteng extract.

Method: The following were blended together until homogeneous: 8.0 kg sucrose, 5.9 kg maltodextrin, 3.5 kg fructose, 2.7 kg cocoa powder, 2.0 kg malic acid, 900 grams sodium citrate, 500 grams potassium monophosphate, 146 grams sodium chloride, 140 grams calcium lactate, 140 grams calcium silicate, 100 grams gum Arabic, 96 grams caffeine, and 4.2 grams Jixueteng extract. The mixture is tumbled until homogeneous.

24 grams of powder has: 300 mg sodium, 140 mg potassium, 95 mg caffeine, and 10 mg Jixueteng extract

### Example 5. Caffeinated Energy Drink

Ingredients: Purified Water, Sucrose, Maltodextrin, Cyclodextrin, Taurine, Caffeine, Sodium Citrate, Potassium Citrate, Calcium Citrate, Magnesium Citrate, Pueraria lobata Powder, Vitamin B6, Vitamin B12

Method: To a mixing container is added 325 kg of purified water. The purified water is heated to 50° C. To the heated water is added a homogeneous mixture of 35 kg of sucrose, 7 kg maltodextrin, and 5 gamma-cyclodextrin. The carbohydrates are allowed to fully dissolve. To the solution is then added 111 g of caffeine and 1.11 kg of taurine which are allowed to fully dissolve. A blend of 518 grams sodium citrate, 29 grams potassium citrate, 170 grams calcium citrate, and 49 grams of magnesium citrate is mixed and added to the solution until fully dissolved; 10.5 grams of ginkgo biloba powder is added and allowed to dissolve. To this mix is added 7.3 grams pyridoxal 5′-phosphate and 0.073 grams hydroxocobalamin. The system is heated to 85° C. for 30 minutes after which 400 grams of watermelon flavor added and 10 grams red color and chilled.

369-gram serving has: 108 mg Caffeine, 1080 mg Taurine, 20 mg Pueraria lobata, 7.1 mg Vitamin B6, 7.1 mg Vitamin B12, 140 mg Sodium, 11 mg Potassium

### Example 6. Caffeinated Energy Drink

Ingredients: Purified Water, Sucrose, Maltodextrin, Cyclodextrin, Taurine, Caffeine, Sodium Citrate, Potassium Citrate, Calcium Citrate, Magnesium Citrate, Gotu Kola Powder, Vitamin B6, Vitamin B12

Method: To a mixing container is added 325 kg of purified water. The purified water is heated to 50° C. To the heated water is added a homogeneous mixture of 34 kg of sucrose, 7 kg maltodextrin, and 5 gamma-cyclodextrin 1.4 kg of cocoa powder. The carbohydrates are allowed to fully dissolve. To the solution is then added 111 g of caffeine and 1.11 kg of taurine. A blend of 518 grams sodium citrate, 29 grams potassium citrate, 170 grams calcium citrate, and 49 grams of magnesium citrate is mixed and added to the solution until fully dissolved; 10.5 grams of Gotu Kola powder is added and allowed to dissolve. To this mix is added 7.3 grams pyridoxal 5′-phosphate and 0.073 grams hydroxocobalamin. The system is heated to 85° C. for 30 minutes after which the product is chilled.

### Example 7. Coffee Blends

Ingredients: Coffee Beans, Hazelnut Powder, Sucrose, Gingko Biloba

Method: To 480 kg of roasted coffee beans is added 15 kg of ground hazelnut powder, 4.9 kg of sucrose and 100 grams of ginkgo biloba powder. The components were allowed to sit together for 5 days at which time the components were ground together.

Deoxygenated purified water was passed through a series of five to eight columns of the above ground coffee mixture. The water first passed through several “hot” cells at 140-180° C., at higher-than-atmospheric pressure, for extraction of difficult components like carbohydrates. The initial extract was then passed through two or more “cold” cells at 100° C. The extract was passed through a heat exchanger to cool it to about 40° F. (5° C.). The ground extract contained up to 40% solids.

The liquid concentrate is sprayed through a nozzle at the top of a drying tower. The tower was at least 23 m tall. Air heated to about 250° C. was blown downward through the mist to evaporate the water. The air was diverted out of the tower near the bottom, and it is filtered to remove fine particles, which optionally was recirculated back through the tower to agglomerate the particles. The dry coffee powder collected in the bottom of the tower before being discharged for further processing. The resulting powder contained 2-4% moisture and consisted of free-flowing, non-dusty particles.

The moisture laded air was condensed. The water was then removed by freeze drying to yield an oil. The oil was then slowly sprayed onto the free-flowing powder from above, which caused the particles to further agglomerate.

### Example 8. Coffee Chocolate Blends

Ingredients: Instant Coffee, Cocoa Powder, High Fat Milk Powder, Sucrose, Korean red ginseng extract, Sodium Benzoate, Potassium Sorbate

Method: To 480 kg of instant coffee powder is added 8 kg cocoa powder, 6.9 kg of sucrose, 5 kg milk powder, 100 grams Korean red ginseng powder, 2.5 grams sodium benzoate, 2.5 grams potassium sorbate. The components were allowed to sit together for 5 days at which time the components were ground together to a fine powder. To a tumbling bin of the fine powder was slowly sprayed 500 grams of purified water which lead the particles to agglomerate.

### Example 9. Beverage Companion Flavor Package

Ingredients: Sucrose, Fructose, Xanthan Gum, Malic Acid, Sodium Benzoate, Potassium Sorbate, High Lauric Vegetable Fat, Sodium Caseinate, Ginkgo Biloba, Mono/diglyceride Emulsifier (Cremodon 250/20), Dipotassium Hydrogen Phosphate, Sodium Carbonate.

Method: A emulsion is prepared, by first dissolving 36.5 kg sucrose, 18.0 kg fructose and 7.0 kg sodium caseinate in 90.7 kg warm water at 50° C., followed by the addition of 3 kg of the emulsifier and 400 grams of Ginkgo Biloba powder. To this was dissolved 2.45 kg of dipotassium hydrogen phosphate and 0.27 kg of sodium carbonate. A melted fat phase was prepared from high lauric coconut oil at the same time and kept at a temperature no higher than 50° C. 31 kg of the melted fat phase was then poured into the aqueous phase with agitation to cause emulsification, at a temperature no higher than 50° C. The resultant emulsion was then homogenized under a pressure of 4000 psi. To the solution is added 0.85 kg of almond flavor and color.

Optionally, the above emulsion was passed to a spray drier of conventional design with centrifugal pressure nozzles and dried to a powder of 2% moisture content. An inlet temperature of 400° F. and an outlet temperature of 200° F. was employed, to give somewhat less than 98 kg dried product.

### Example 10. Flavor Package

Ingredients: Sucrose, Fructose, Xanthan Gum, Malic Acid, Sodium Benzoate, Potassium Sorbate, High Lauric Vegetable Fat, Sodium Caseinate, Danshen extract powder, Mono/diglyceride Emulsifier (Cremodon 250/20), Dipotassium Hydrogen Phosphate, Sodium Carbonate.

Method: A emulsion is prepared, by first dissolving 30.0 kg sucrose, 17.0 kg fructose, 7.5 kg cocoa powder, and 7.0 kg sodium caseinate in 90.7 kg warm water at 50° C., followed by the addition of 3 kg of the emulsifier and 400 grams of danshen extract powder. To this was dissolved 2.45 kg of dipotassium hydrogen phosphate and 0.27 kg of sodium carbonate. A melted fat phase was prepared from high lauric coconut oil at the same time and kept at a temperature no higher than 50° C. 31 kg of the melted fat phase was then poured into the aqueous phase with agitation to cause emulsification, at a temperature no higher than 50° C. The resultant emulsion was then homogenized under a pressure of 4000 psi. To the solution is added 0.85 kg of almond flavor and color.

Optionally, the above emulsion was passed to a spray drier of conventional design with centrifugal pressure nozzles and dried to a powder of 2% moisture content. An inlet temperature of 400° F. and an outlet temperature of 200° F. was employed, to give somewhat less than 98 kg dried product.

### Example 10. Flavor Package

Ingredients: Sucrose, Fructose, Xanthan Gum, Malic Acid, Sodium Benzoate, Potassium Sorbate, High Lauric Vegetable Fat, Sodium Caseinate, cocoa, Schisandra extract, Mono/diglyceride Emulsifier (Cremodon 250/20), Dipotassium Hydrogen Phosphate, Sodium Carbonate.

Method: A emulsion is prepared, by first dissolving 30.0 kg sucrose, 17.0 kg fructose, 7.5 kg cocoa, ginko biloba and danshen mix, and 7.0 kg sodium caseinate in 90.7 kg warm water at 50° C., followed by the addition of 3 kg of the emulsifier. To this was dissolved 2.45 kg of dipotassium hydrogen phosphate and 0.27 kg of sodium carbonate. A melted fat phase was prepared from high lauric coconut oil at the same time and kept at a temperature no higher than 50° C. 31 kg of the melted fat phase was then poured into the aqueous phase with agitation to cause emulsification, at a temperature no higher than 50° C. The resultant emulsion was then homogenized under a pressure of 4000 psi. To the solution is added 0.85 kg of almond flavor and color.

Optionally, the above emulsion was passed to a spray drier of conventional design with centrifugal pressure nozzles and dried to a powder of 2% moisture content. An inlet temperature of 400° F. and an outlet temperature of 200° F. was employed, to give somewhat less than 98 kg dried product.

### Example 11. Beverage condiment

Ingredients: raw sugar, ginkgo biloba and danshen

Method: Thoroughly mix 100 grams of raw sugar with 500 mg of Gingko biloba and danshen powder. Package the mixed powder into individual package with each packaging containing 5 grams of sucrose.

### Example 12. Beverage Condiment

Ingredients: stevia extract, maltodextrin, danshen and Pueraria lobata extract mix

Method: Thoroughly mix 100 grams of maltodextrin with 500 mg of stevia extract and 500 mg of danshen and Pueraria lobata powder. Package the mixed powder into individual package.

### Example 13. Beverage Condiment

Ingredients: erythritol, rebiana, ginkgo biloba

Method: Thoroughly mix 100 grams of erythritol with 500 mg of rebiana and 500 mg of Gingko biloba. Package the mixed powder into individual package.

What is claimed is:

1. An edible composition, comprising a caffeinated composition and a modulating composition, wherein the modulating composition comprises an adrenergic receptor antagonist, an adrenergic receptor agonist, a calcium channel blocker, an ACE inhibitor, an angiotensin II receptor antagonist, an aldosterone antagonist, a vasodilator, a centrally acting adrenergic compound, a PAF receptor inhibitor, or a combination thereof.

2. The edible composition of claim 1, wherein the caffeinated composition comprises natural caffeine, synthetic caffeine, caffeine-containing plant extract or powder, or a combination thereof.

3. The edible composition of claim 1, wherein the caffeinated composition comprises caffeine, green coffee bean powder or extract, green tea powder or extract, white tea powder or extract, black tea powder or extract, guarana powder or extract, yerba mate powder or extract, cola nut powder or extract, cocao powder or extract, coffee powder or extract, or a combination thereof.

4. The edible composition of claim 1, wherein the edible composition comprises at least 1% caffeine by weight.

5. The edible composition of claim 1, wherein the modulating composition comprises powder, extract, isolate or derivative of a herb comprising danshen (Salvia miltiorrhiza), Pueraria lobata, danggui, safflower, Annona muricate, guan-mu-tong (Aristolochia manshuriensis), Cassia absus, Chinese Hawthorn (Crataegus pinnatifida), pima cotton (Gossypium barbadense), Hibiscus sabdariffa, Musanga cecropiodes, Uncaria rhynchophylla, Actinidia arguta radix (Tengligen), Glycyrrhizae radix et rhizoma (Gancao), Peucedani radix (Qianhu), Spatholobi caulis (Jixueteng), Schisandra (Schisandra chinensis), Jiaogulan (Gynostemma pentaphyllum), Gotu Kola (Centella asiatica), Ginkgo biloba, Ginger root, Catuaba (Erythroxylum catuaba), Korean red ginseng, or a combination thereof.

6. The edible composition of claim 5, wherein the modulating composition further comprises cocoa, grape seed, turmeric, theanine, piraletam, citicoline, blueberry extract or isolates, arginine, vitamin E, bacopa, curcumin, ginseng, citrulline, icariin, forsklin, S-denosyl-L-methionine, quercetine, taurine, or isolates, extracts or derivatives thereof.

7. The edible composition of claim 1, wherein the modulating composition comprises cat's claw (Uncaria tomentosa, Uncaria guianensis), lavender, cinnamon (Cinnamomum verum), Yarrow (Achilea millefolium), hawthorn, garlic, Buchu (Agathosma betulina), prickly custard apple (Annona muricata), Cassia occidentalis (Coffee weed), Hibiscus sabdariffa (Roselle), or plant parts, extract, isolates or powders thereof.

8. The edible composition of claim 1, wherein the modulating composition comprises epicatechin, catechin, quercetin, kaempferol, isorhamnetin, amentoflavone, bilobetin, isoginkgetin, ginkgetin, sciadopitysin, or a combination thereof.

9. The edible composition of claim 1, further comprising a flavor-masking agent, wherein the flavor-masking agent is capable of interacting with the caffeinated composition and reducing the bitterness from the caffeinated composition.

10. The edible composition of claim 1, wherein the flavor-masking agent comprises nucleic acid, DNA, RNA, protein, peptide, cluster dextrin, cyclodextrin, polydextrose, resistant starch, porphyrin, polyethylene glycol, polyunsaturated hydrocarbons, polyunsaturated fatty acids, cellulose, lignin, plant particles, N-acetoglucosamine, or a combination thereof.

11. The edible composition of claim 1, wherein the plant particles are derived from husk, seed, seed shell, nut, nut shell, fruit, flower, stem, leaf, rice husk, nut shell, woody root, stem or leaves, corn husk, oat husk, grain husk, yeast, mushroom, berry fruit or seed, raspberry fruit or seed, blackberry fruit or seed, blueberry fruit or seed, strawberry fruit or seed, melon, vegetable, or a combination thereof.

12. The edible composition of claim 1, further comprising an antioxidant composition, an anti-inflammatory composition, a vitamin composition, a mineral composition, an amino acid composition, or a synergistic composition.

13. The edible composition of claim 12, wherein the synergistic composition comprises magnesium, L-theanine, theobromine, or a combination thereof.

14. The edible composition of claim 1, further comprising an additive selected from sweeteners, food acids, flavoring agents, coloring agents, humectants, bulking agents, fatty acids, triglycerides, plasticizers, emulsifiers, thickeners, preservatives, or and a mixture thereof.

15. A food or beverage, comprising the edible composition of claim 1.

16. The food or beverage of claim 15, wherein the food or beverage is a caffeinated candy, a caffeinated chocolate, a caffeinated chew, a chewing gum, a chewable tablet, a caffeinated gummy, an instant coffee blend, an instant tea blend, a protein blend, an energy bar, an energy drink, a syrup, a concentrated beverage powder, a coffee drink, a tea drink, a soda, a dairy drink, a chocolate drink, an effervescent tablet, or a carbonated drink.

17. A method for reducing caffeine side effects, comprise administering to a subject a modulating composition with a caffeinated composition, wherein the modulating composition is configured to counteract, modulate or reduce caffeine's side effect, reduce caffeine's bitterness, or a combination thereof, wherein the modulating composition comprises ginkgo biloba, danshen extract, Pueraria lobata, dangui, safflower, berry fruit or seed powder, cluster dextrin, cyclodextrin, polydextrose, its extract, isolate, powder, derivative, or a combination thereof.

18. The method of claim 17, wherein the modulating composition and the caffeinated composition are administered simultaneously or in close time proximity.

19. A kit, comprising a modulating composition and an instruction, wherein the instruction comprises information instructing a user to consume the modulating composition with a caffeinated composition simultaneously or in close time proximity, wherein the modulating composition is configured to counteract, modulate or reduce caffeine's side effect, reduce caffeine's bitterness, or a combination thereof, wherein the modulating composition comprises ginkgo biloba, danshen extract, Pueraria lobata, dangui, safflower, berry fruit or seed powder, cluster dextrin, cyclodextrin, polydextrose, its extract, isolate, powder, derivative, or a combination thereof.

20. The kit of claim 19, wherein the instruction comprises information instructing a user to combine the modulating composition with a edible composition to provide a combined composition, and consume the combined composition.
